(19) United States
(12) Patent Application Publication
(10) Pub. No.: US 2011/0097584 A1
(43) Pub. Date: Apr. 28, 2011

(54) SOFT MAGNETIC MATERIAL, POWDER MAGNETIC CORE AND METHOD FOR MANUFACTURING THE SAME

(75) Inventors: Takeshi TAKAHASHI, Tokyo (JP); Seigo TOKORO, Tokyo (JP)

(73) Assignee: TDK CORPORATION, Tokyo (JP)

(21) Appl. No.: 12/904,556

(22) Filed: Oct. 14, 2010

(30) Foreign Application Priority Data
Oct. 26, 2009 (JP) 2009-245787

(51) Int. Cl. B32B 5/16; B22F 3/12

(52) U.S. Cl. 428/403; 419/29

(57) ABSTRACT

It is an object to provide a novel soft magnetic material that enables the fabrication of a powder magnetic core capable of suppressing degradation in performance due to a high-temperature treatment and achieving high core resistance and low loss.

A soft magnetic material comprising: a core particle each having a soft magnetic particle comprising iron as a main component and an insulating film formed on a surface of the soft magnetic particle; and a coating layer formed on the core particle, wherein the coating layer comprises a metal complex having nonferrous central metal and at least one organic ligand.

### CROSS-REFERENCES TO RELATED APPLICATIONS

This application relates to and claims priority from Japanese Patent Application No. 2009-245787, filed on Oct. 26, 2009, the entire disclosure of which is incorporated herein by reference.

### BACKGROUND

1. Field of the Invention

The present invention relates to a soft magnetic material, as well as a powder magnetic core and a method for manufacturing the same.

2. Description of Related Art

Conventionally, powder magnetic cores have been used as magnetic cores provided in electromagnetic devices such as motors, generators and reactors. In general, the powder magnetic cores of this type are produced by compacting a soft magnetic material (powder) containing iron as the major component on which a thin insulating film is formed by a phosphate treatment or the like for the purpose of improving an insulating property and increasing the density of magnetic flux. After the compaction, a heat treatment (annealing) is performed in order to release compression strain caused during the compaction and thereby reduce iron loss (core loss).

Powder magnetic cores that are driven in an alternating magnetic field are generally required to exhibit a small core loss. It is effective to increase the temperature in a heat treatment in order to reduce the core loss. However, in a powder magnetic core fabricated using iron powder which has been subjected to an insulating treatment such as a phosphate treatment, since the heat resistance of a phosphoric acid film is low, a core resistance is likely to be reduced by a heat treatment of 500° C. or higher and an eddy-current loss increases, and as a result, the core loss cannot be sufficiently reduced.

In order to solve such a problem, for example, Patent Document 1 discloses a soft magnetic material obtained by: forming an insulating film on iron powder which has been subjected to phosphate, by using a metal alkoxide to form composite magnetic particles; and further coating the composite magnetic particles with silicone resin. Also, Patent Document 1 discloses that, by fabricating a powder magnetic core using this soft magnetic material, the powder magnetic core which exhibits low loss with reduced degradation in a high-temperature treatment can be obtained.

Patent Document 2 discloses a soft magnetic material obtained by forming a lower film containing a nonferrous metal on iron powder and then forming an upper film using a metal alkoxide. Also, Patent Document 2 discloses that, by fabricating a powder magnetic core using this soft magnetic material and polyphenylene sulfide resin, the powder magnetic core which exhibits low loss with reduced degradation in a high-temperature treatment can be obtained.

Patent Document 3 discloses a soft magnetic powder composition obtained by treating soft magnetic iron-based core particles having a phosphorous-containing insulating coating on the surfaces thereof using a lubricant having a specific structure containing an alkoxy group (organo-silane, organo-titanate, organo-aluminate or organo-zirconate). Also, Patent Document 3 discloses that, by fabricating a powder magnetic core using this soft magnetic powder composition, a powder magnetic core having high density and high strength while exhibiting low loss can be obtained.
[Patent Document 1] Japanese laid-open publication No. 2006-128663
[Patent Document 2] Japanese laid-open publication No. 2007-042891
[Patent Document 3] Published Japanese translation of PCT application, No. 2006-511711

Although it is known that a reduction in a core resistance resulting from a heat treatment and an increase in a core loss associated therewith can be suppressed by forming a film that improves the heat resistance using a metal alkoxide as described above with reference to the related art, further improvements are still required. In addition, there have been demands for high-performance powder magnetic cores which not only achieve high core resistance and low core loss, but also achieve similar or greater performance in other properties required for powder magnetic cores (e.g., green density, magnetic permeability and strength) as compared to the related art.

### SUMMARY

The present invention has been made in light of the above circumstances, and the first object of the present invention is to provide: a novel soft magnetic material capable of suppressing degradation in performance due to a high-temperature treatment and thereby enabling the fabrication of a powder magnetic core with high core resistance and low loss; and such a powder magnetic core.

The second object of the present invention is to provide: a soft magnetic material capable of enabling the fabrication of a novel powder magnetic core which not only achieves high core resistance and low loss, but also achieves high magnetic permeability, high density and high strength, by way of compaction under a heating temperature, i.e., a so-called warm-compaction; and a manufacturing method that is excellent in productivity and cost efficiency and is capable of manufacturing such a powder magnetic core easily and at a low cost.

The inventors of the present invention have committed to intensive research and found that the above problems can be solved by forming a coating layer on the surface of each core particle using a specific metal complex, thereby achieving the present invention.

Specifically, a soft magnetic material according to a first aspect of the present invention includes: a core particle having a soft magnetic particle comprising iron as a main component thereof and an insulating film formed on a surface of the soft magnetic particle; and a coating layer formed on the core particle, in which the coating layer comprises a metal complex having a nonferrous central metal and at least one organic ligand.

After measuring the properties of the powder magnetic core fabricated using the above soft magnetic material, the inventors found that, in the powder magnetic core, degradation in performance due to a high-heat treatment was suppressed and high core resistance and low core loss could be achieved. Also, the inventors found that the powder magnetic core had high magnetic permeability, high density and high strength. Although the details of a functional mechanism that contributes to such effects are still unclear, for example the following presumption can be made.

In the above soft magnetic material, since there is provided a coating layer comprising an organic metal complex having excellent heat resistance and film formability, i.e., a metal complex having a nonferrous central metal and at least one organic ligand, the heat resistance, adhesiveness and uniformity of the coating layer have been improved as compared to the case where a metal alkoxide is used as in the related art. In other words, since the coating layer comprising an organic metal complex having excellent heat resistance and film formability is formed in the above soft magnetic material, the periphery of the core particle is coated uniformly and sufficiently, and thus the insulation property and heat resistance thereof are improved. Accordingly, it can be conceived that degradation in the performance due to the high-temperature treatment is suppressed in the above soft magnetic material, and a powder magnetic core with high core resistance and low loss can be fabricated. On the other hand, the metal alkoxide used in the related art might cause local agglomeration of oxide during a warm-compaction, and thus it can be conceived that a uniform coating cannot be maintained, which leads to degradation in the core resistance. However, the effects are not limited thereto.

In the above configuration, it is preferable that at least one multidentate ligand is contained as the organic ligand. The stabilization effect provided by the multidentate ligand improves the heat resistance, adhesiveness and uniformity of the coating layer, which results in improvements in the insulation property and heat resistance of the core particle. Multidentate ligands from bidentate ligands to tetradentate ligand may be preferable.

In the above configuration, the metal complex is preferably a metal chelate complex. The use of such a metal chelate complex significantly improves the heat resistance, adhesiveness and uniformity of the coating layer with its chelating effect, which results in significant improvements in the insulation property and heat resistance of the core particle.

In the above configuration, it is preferable that the nonferrous central metal of the metal complex is contained in an amount from 0.001 to 1.0 mol % with respect to the iron contained in the core particle. In this range, it is possible to achieve not only high core resistance and low core loss, but also similar or greater performance in green density, magnetic permeability and strength as compared to the related art.

In the configuration above, the nonferrous central metal is preferably at least one type selected from the group consisting of Al, Mg, Mn, Ti, Co and Zr. The use of a metal complex containing metal capable of forming a metal oxide having excellent heat resistance as the nonferrous central metal further improves the insulation property and heat resistance of the core particle.

The soft magnetic particle preferably contains 95% or more iron. The soft magnetic particle containing 95% or more iron tend to exhibit lower Vicker's hardness and superior compactability as compared to the above-mentioned Fe—Al—Si based alloy particle in the related art and iron-based soft magnetic particle having a purity of 95% or less. Accordingly, by using the soft magnetic particle containing 95% or more iron, even higher density can be achieved, which is accompanied by the achievement of high strength and high magnetic permeability.

A soft magnetic material according to a second aspect of the present invention is obtainable by: applying a metal complex having a nonferrous central metal and at least one organic ligand onto a core particle having a soft magnetic particle containing iron as a main component and an insulating film formed on the soft magnetic particle; and thereby forming a coating layer. Degradation in performance due to a high-temperature treatment can be suppressed, and thereby achieve a soft magnetic material that enables the fabrication of the powder magnetic core with high core resistance and low loss, easily and at a low cost, and therefore productivity and cost efficiency can be improved.

A method for manufacturing the powder magnetic core according to the present invention can be effectively obtained using the above-described soft magnetic material of the present invention, the method at least including: warm-compacting a mixture containing the above-described soft magnetic material of the present invention and a lubricant; and performing a heat treatment for a compact obtained after the warm-compaction. By warm-compacting the compact by adding a lubricant to the above-described soft magnetic material of the present invention, the soft magnetic material is coated with the lubricant and thus provided with high insulation property, which results in the achievement of a powder magnetic core with high core resistance and low core loss easily and at a low cost, and moreover, the productivity and cost efficiency can be improved.

In the above-described method for manufacturing the powder magnetic core, it is preferable that the warm-compaction is carried out at a temperature from 50 to 150° C. in the step of warm-compaction. By applying heat during the compaction, even higher density can be achieved, which is accompanied by the achievement of high strength and high magnetic permeability. In the step of performing the heat treatment, the heat treatment is preferably performed at a temperature from 450 to 600° C.

In the step of performing the heat treatment, the heat treatment is preferably performed in an oxygen-containing atmosphere. By performing the heat treatment in the oxygen-containing atmosphere, decompositions in the insulating film and the coating layer are suppressed, and the core resistance can be significantly increased, while the core loss can be significantly reduced.

A powder magnetic core according to the present invention can be effectively obtained by the above-described method for manufacturing a powder magnetic core of the present invention, the powder magnetic core being fabricated by performing heat treatment for a compact that is obtained by warm-compacting a mixture containing the above-described soft magnetic material of the present invention and a lubricant.

It is more preferable that a green density is 7.60 g/cm³ or higher. Even higher strength and higher magnetic permeability can be achieved.

The present invention can achieve a powder magnetic core with high core resistance and low loss, and in addition, the present invention can also provide a novel powder magnetic core that not only exhibits the high core resistance and low loss, but also exhibits high magnetic permeability, high density and high strength. Also, since such a powder magnetic core can be manufactured easily and at a low cost, the productivity and cost efficiency can be improved.

### BRIEF DESCRIPTION OF THE DRAWINGS

FIG. 1 is a flowchart showing a method for manufacturing a soft magnetic material and a powder magnetic core according to an embodiment.

### DETAILED DESCRIPTION OF PREFERRED EMBODIMENTS

An embodiment of the present invention will be described below. Note that the following embodiment is merely an example for explaining the present invention, and the present invention should not be limited to this embodiment.

A soft magnetic material in this embodiment includes: core particles (composite magnetic particles) obtained by forming an insulating film on the surface of each soft magnetic particle; and a coating layer formed on each of the core particles, the coating layer containing a metal complex having a non-ferrous central metal and at least one organic ligand.

The soft magnetic particles constituting the core particles are iron base powder (particles, powder) containing iron (which includes pure iron and iron containing inevitable impurities) as the main component. Specific examples of the soft magnetic particles include: those containing only iron; and a composition containing iron and a small amount of other elements (e.g., Si, P, Co, Ni, Cr, Al, Mo, Mn, Cu, Sn, Zn, B, V and Sn) added to the iron. Also, the soft magnetic particles may be, in addition to element metal and element metal with (an)other element(s) added thereto, alloys such as an Fe—Si based alloy, an Fe—Al based alloy, an Fe—N based alloy, an Fe—C based alloy, an Fe—B based alloy, an Fe—Co based alloy, an Fe—P based alloy, an Fe—Ni—Co based alloy, an Fe—Cr based alloy, an Fe—Al—Si based alloy, etc. They may be used alone or in combination.

Examples of preferable soft magnetic particles include, but are not particularly limited to, those containing 99 wt % or more iron (pure iron). The soft magnetic particles containing 99% or more iron tend to have lower Vicker's hardness and superior compactability as compared to the above Fe—Al—Si based alloy particles in the related art and iron-based soft magnetic particles with a purity of less than 99%, and therefore the use of such soft magnetic particles allows for the achievement of even higher density and improvement of magnetic properties. In particular, a composition containing 0.5 wt % or less P, 0.1 wt % or less Mn, 0.03 wt % or less Al, V, Cu, As or Mo, and the balance iron is more preferable.

The particle diameter of soft magnetic particles is not particularly limited and may be appropriately set in accordance with desired performance. Note that the particle diameter of soft magnetic particles affects the density and magnetic permeability of a powder magnetic core to be formed, and a larger diameter tends to cause the soft magnetic particles to be deformed due to pressure during warm-compaction and to increase the density. Accordingly, an average diameter of about from 20 to 300 μm is preferable as the particle diameter of the soft magnetic particles. Note that the average diameter herein refers to the particle diameter of D50%.

The soft magnetic particles may be manufactured by well-known methods, and the process thereof is not particularly limited. Soft magnetic particles having an arbitrary composition and an arbitrary particle diameter can be obtained using well-known processes such as, for example, an ore reduction process, a mechanical alloying process, a gas-atomization process, a water atomization process, a rotary atomization process and a cast-crushing process.

The insulating film is formed on the surface of each soft magnetic particle to provide insulation to the soft magnetic particle. The insulating film is not particularly limited as long as it can provide insulation to the surfaces of the soft magnetic particles, examples of which may include iron phosphate, iron borate, iron sulfate, iron nitrate, iron acetate, iron carbonate, silica, titania, zirconia, magnesia, alumina, chrome oxide and zinc oxide, where one type thereof may be used alone or two or more types thereof may be used in combination. In terms of resistivity to heat, the insulating film may preferably be iron phosphate, silica, titania, zirconia, magnesia, alumina, chrome oxide, zinc oxide, etc., and more preferably iron phosphate.

The thickness of the insulating film is not particularly limited, but is preferably about from 0.001 to 30 μm. With the thickness within this range, required insulation property and high magnetic permeability tend to be easily ensured.

The metal complex constituting the coating layer has nonferrous central metal and at least one organic ligand. Note that the metal complex refers to a compound having a structure that has a metal atom at the center and at least one surrounding ligand coordinated thereto.

The nonferrous central metal is not particularly limited and may be any metal excluding iron. However, the nonferrous central metal is preferably metal that can form a metal oxide having excellent heat resistance, e.g., at least one type selected from the group consisting of Al, Mg, Mn, Ti, Co and Zr, and more preferably at least one type selected from the group consisting of Al, Mg, Ti and Zr in terms of resistivity to heat.

The organic ligand is a ligand constituted from C, H, O and F. Since the metal complex has the organic ligand, a coating layer having excellent heat resistance and film formability can be formed. Examples of the preferable organic ligand include, but are not particularly limited to, multidentate ligands such as acetylacetonate, ethyl acetoacetate, and trifluoroacetylacetonate, hexafluoroacetylacetonate.

A metal complex may generally have the coordination number of from 2 to 12, in accordance with the oxidation number of the nonferrous central metal. The coordination number of the organic ligand is preferably from 1 to 6, and more preferably from 2 to 5. Note that when the metal complex has a plurality of organic ligands, the organic ligands may be the same as or different from each other.

A preferable metal complex may be a metal chelate complex having a central nonferrous metal and at least one organic multidentate ligand. By using a metal chelate complex that is stable due to the chelating effect, a coating layer having excellent heat resistance and film formability can be formed. Another preferable metal complex may be a metal chelate complex having a nonferrous central metal and a plurality of organic multidentate ligands.

Specific examples of the metal complex include, but are not particularly limited to, zirconium tetraacetylacetonate, zirconium tributoxyacetylacetonate, zirconium acetylacetonate bis(ethylacetoacetate), aluminum ethylacetoacetate diisopropylate, aluminum trisethyl acetoacetate, aluminum bisethyl acetoacetate monoacetylacetonate, aluminum acetylacetonate, magnesium acetylacetonate, magnesium bis-trifluoroacetylacetonate, magnesium hexafluoroacetylacetonate, manganese acetylacetonate, cobalt acetylacetonate, copper acetylacetonate, titanium acetylacetonate, titanium oxyacetylacetonate, where one type thereof may be used alone or two or more types thereof may be used in combination.

The content of the metal complex is not particularly limited, but the content is preferably from 0.001 to 1.0 mol % based on the ratio of nonferrous central metal to the iron contained in the core particles, and more preferably from 0.002 to 0.5 mol %. If the content of the metal complex is less than 0.001 mol %, the heat resistance tends to be low, while if the content is greater than 1.0 mol %, the magnetic permeability and green density tend to be lowered.

The powder magnetic core of this embodiment can be fabricated by performing a heat treatment for a compact obtained by warm-compacting a mixture containing the soft magnetic material of the above embodiment and a lubricant. The following description describes a preferred method for manufacturing the soft magnetic material and the powder magnetic core according to this embodiment.

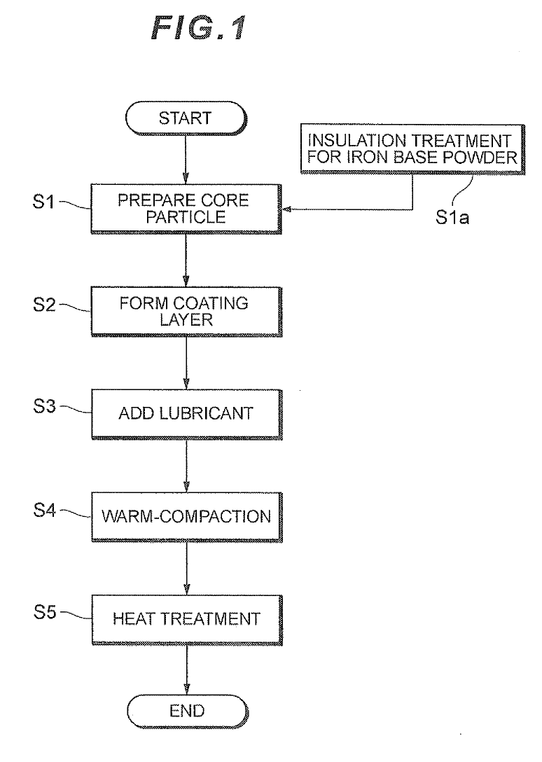

FIG. 1 is a flowchart showing steps for manufacturing the soft magnetic materials and the powder magnetic core according to this embodiment. The soft magnetic material according to this embodiment is fabricated through the step of preparing core particles having an insulating film is formed on the surface of each soft magnetic particle (S1) and the step of forming a coating layer by applying a metal complex on each core particle (S2). The powder magnetic core according to this embodiment is fabricated through the step of adding lubricant to such a soft magnetic material of this embodiment (S3), the step of warm-compacting the resulting mixture, i.e., the mixture containing at least the core particles each having the coating layer formed thereon and the lubricant (S4), and the step of performing a heat treatment for a compact obtained after the warm-compaction (S5).

In the step of preparing the core particles (S1), the core particles are obtained by performing insulating treatment on the surface of each soft magnetic particle, namely iron base powder, and thereby forming an insulating film thereon (S1a). The insulating treatment method for the soft magnetic particles is not particularly limited as long as the method can form an insulating film having a composition whose examples are described above. Known methods may be appropriately employed; for example, the iron base powder is treated with an aqueous solution containing phosphoric acid and/or phosphate (e.g., an aqueous solution containing 80-90% orthophosphoric acid (H₃PO₄)) and then dried. Note that step S1a above can be omitted by purchasing commercially-available core particles in which an insulating film is formed on each soft magnetic particle, i.e., iron powder.

In the step of forming the coating layer (S2), the coating layer is formed by applying a metal complex on the core particles. In this way, the soft magnetic material according to this embodiment can be obtained. The method for applying the metal complex is not particularly limited and known methods can be appropriately employed, such as a method in which an application liquid with a metal complex dispersed or dissolved in a solvent is applied to the core particles and then dried.

When the metal complex is applied, a mixing process may be performed as needed using a kneader, a mixer, a stirrer, a granulator, a disperser, or the like. In terms of improvements in the uniformity and adhesiveness of the coating layer, it is preferable to employ a spray process in which an application liquid with the metal complex dispersed or dissolved in a solvent is sprayed and applied onto the core particles using a spray gun or the like. Examples of the solvent usable in the spray process include, but are not particularly limited to, oils such as mineral oil, synthetic oil and vegetable oil, as well as organic solvents such as toluene, acetone and alcohol.

In the step of adding a lubricant to the soft magnetic material (S3), the lubricant is added to the soft magnetic material according to this embodiment, i.e., the soft magnetic material in which the coating layer containing a predetermined metal complex is formed on each of the core particles.

Although lubricants known in this field may be appropriately selected and used without any particular limitation, a metal soap is preferably used. The lubricant improves the fluidity of the soft magnetic material (powder) during the warm-compaction and promotes deformation in the soft magnetic material when a pressure is applied, and the lubricant can also serve as an insulating layer provided between the core particles and as a protection layer provided between the core particles. Such a metal soap allows for the formation of a uniform film on the periphery of the soft magnetic material easily during the warm-compaction and has an excellent insulation property, and therefore the metal soap is particularly suitable for use as the lubricant for the above manufacturing method. Specific examples of the metal soap include zinc oleate, zinc stearate, aluminum stearate, calcium stearate and copper stearate, where one type thereof may be used alone or two or more types thereof may be used in combination.

The loading of the lubricant is not particularly limited, but is preferably from 0.02 wt % to 0.2 wt % based on the total mass of the soft magnetic material and the lubricant. If the loading of the lubricant is less than 0.02 wt %, the amount of the lubricant is too small with respect to the soft magnetic material, and thus the lubricant tends to be not distributed uniformly on the periphery of the soft magnetic material. On the other hand, if the loading of the lubricant is greater than 0.2 wt %, the amount of lubricant is too much with respect to the soft magnetic material, and thus the effect of adding the lubricant tends to be saturated, and furthermore, it becomes difficult to achieve high density and high magnetic permeability since the content of the soft magnetic material is reduced.

In the step of adding the lubricant to the soft magnetic material (S3), in order to distribute the added lubricant uniformly in the soft magnetic material, it is preferable to blend the mixture. Although the blending may be carried out by known methods without any particular limitation, the blending is preferably carried out by a mixer (e.g., an attritor, a vibration mill, a ball mill, a V blender, etc.) or a granulator (e.g., a fluid-bed granulator, an oscillating granulator, etc.).

In the step of warm-compaction (S4), the mixture obtained as described above, i.e., the mixture containing at least the core particles with the coating layer formed thereon and the lubricant, are formed into an arbitrary shape while being subjected to the application of heat and pressure. Although this warm-compaction may be carried out by known methods without any particular limitation, the warm-compaction is preferably carried out using a compression molding having a cavity of a desired shape, where the cavity is filled with the mixture, and the mixture is compressed and compacted under a predetermined compaction temperature and a predetermined compaction pressure.

The compaction temperature in the warm-compaction is not particularly limited, but it is generally from 80° C. to 200° C., preferably from 100° C. to 160° C., and more preferably from 120° C. to 140° C. Note that, although the density of the compact tends to increase in accordance with the increase in the compaction temperature, a temperature greater than 200° C. tends to promote oxidation of the core particles (soft magnetic particles), which degrades the performance of the resulting powder magnetic core, and also tends to increase the production cost, which might degrade productivity and cost efficiency.

The compaction pressure in the warm-compaction is not particularly limited, but is generally from 6 ton/cm² to 12 ton/cm². If the compaction pressure in the warm-compaction is below 6 ton/cm², it tends to be difficult to achieve high density and high magnetic permeability by the warm-compaction. On the other hand, if the compaction pressure in the warm-compaction is greater than 12 ton/cm²: the effect of applying pressure tends to be saturated; the production cost tends to increase, which might degrade productivity and the cost efficiency; and the molding die tends to be deteriorated easily and the durability thereof tends to decrease.

In the step of performing a heat treatment for the compact obtained after the warm-compaction (S5), a compression strain generated during the warm-compaction is released to increase the core resistance and reduce the core loss (in particular, the hysteresis loss). The heat treatment may be performed by known processes without being particularly limited, but it is generally preferable to perform a heat treatment for the compact of the soft magnetic material, which has been compacted into an arbitrary shape by the warm-compaction, at a predetermined temperature using an annealing furnace.

The temperature in the heat treatment is not particularly limited, but in general, it is preferably from 450° C. to 600° C. A temperature above 600° C. in the heat treatment tends to promote decomposition in the insulating film and the coating layer and thus degrade the insulation property, which results in a small core resistance. On the other hand, a temperature below 450° C. in the heat treatment tends to suppress decomposition in the insulating film and the coating layer, which results in a large core resistance.

The heat treatment step is preferably carried out under the oxygen-containing atmosphere. Here the oxygen-containing atmosphere may include, but is not particularly limited to, the air atmosphere (in general, containing 20.95% oxygen) or the mixed atmosphere of oxygen and an inert gas such as argon and nitrogen. By performing the heat treatment under the oxygen-containing atmosphere, the decomposition in the insulating film and the coating layer can be suppressed, and the core resistance can be significantly increased while the core loss can be significantly lowered.

The resulting powder magnetic core preferably has a green density of 7.60 g/cm³ or higher. The powder magnetic core with a high green density of 7.60 g/cm³ or higher tends to exhibit excellent performance in various properties such as high magnetic permeability, high strength, high core resistance and low core loss. Note that it is preferable to increase the density of the powder magnetic core in order to improve magnetic properties and mechanical properties. However, increasing the density has a technical limitation due to materials used (the soft magnetic material, metal complex, lubricant, etc.), as well as the amount of use thereof. Accordingly, the powder magnetic core of this embodiment can be considered as significant with respect to the point that the composition and proportion of ingredients that can achieve the green density of 7.60 g/cm³ or higher can be found.

### EXAMPLES

The present invention will be described below in more detail by means of Examples and Comparative Examples, but the present invention is not limited thereto.

### Example 1

First, as core particles having: soft magnetic particles containing iron as the main component; and an insulating film formed on the surface of each soft magnetic particle, pure iron powder coated with an insulating film (trade name “Somaloy 700” manufactured by Höganäs AB; the average particle diameter: 200 μm) was prepared. Next, a metal complex-containing application liquid was prepared by adding zirconium tetraacetylacetonate as a metal complex to toluene. The metal complex-containing application liquid was applied onto the pure iron powder coated with the insulating film and then dried, thereby forming a coating later. A soft magnetic material of Example 1 was fabricated as described above. Note that the content of the metal complex was 0.057 mol % on the basis of the ratio of zirconium to iron contained in the pure iron powder coated with the insulating film.

Then 0.1 wt % zinc stearate was added as a lubricant to the soft magnetic material of Example 1, and the resulting mixture was placed in a mixer (trade name “V-blender” manufactured by TSUTSUI SCIENTIFIC INSTRUMENTS CO., LTD.) and blended with the revolution speed of 12 rpm for 10 minutes. The blended mixture (blended product) was subjected to warm-compaction under the condition where the compaction temperature was 130° C. and the compaction pressure was 980 MPa (10 ton/cm²), thereby fabricating a toroidal core (compact) having the size of 17.5 mm×10.2 mm×about 4 mm (thickness).

The resulting compact was heated to 550° C. with a temperature increase of 5° C./min and then held at 550° C. for one hour, thereby fabricating a powder magnetic core of Example 1. Note that, during the heat treatment, the nitrogen atmosphere was employed until the temperature was increased to about 150° C., and then the atmosphere was shifted to the air atmosphere.

### Example 2

A soft magnetic material of Example 2 and a powder magnetic core of Example 2 were fabricated using the same process as in Example 1, except that aluminum acetylacetonate was used instead of the zirconium tetraacetylacetonate. The content of the metal complex was 0.285 mol % on the basis of the ratio of aluminum to iron contained in the pure iron powder coated with the insulating film.

### Example 3

A soft magnetic material of Example 3 and a powder magnetic core of Example 3 were fabricated using the same process as in Example 1, except that the temperature was increased to 600° C. and then the temperature was maintained at 600° C. for one hour during the heat treatment.

### Example 4

A soft magnetic material of Example 4 and a powder magnetic core of Example 4 were fabricated using the same process as in Example 2, except that the temperature was increased to 600° C. and then the temperature was maintained at 600° C. for one hour during the heat treatment.

### Comparative Example 1

A soft magnetic material of Comparative Example 1 and a powder magnetic core of Comparative Example 1 were fabricated using the same process as in Example 1, except that the application of a metal complex-containing application liquid was omitted and a coating layer was not formed.

### Comparative Example 2

A soft magnetic material of Comparative Example 2 and a powder magnetic core of Comparative Example 2 were fabricated using the same process as in Comparative Example 1, except that the temperature was increased to 600° C. and then the temperature was maintained at 600° C. for one hour during the heat treatment.

### Comparative Example 3

A soft magnetic material of Comparative Example 3 and a powder magnetic core of Comparative Example 3 were fabricated using the same process as in Example 1, except that a metal alkoxide-containing application liquid prepared by adding isopropoxy aluminum to toluene was used instead of the metal complex-containing application liquid. The content of the metal complex was 0.057 mol % on the basis of the ratio of aluminum to iron contained in the pure iron powder coated with the insulating film.

### Comparative Example 4

A soft magnetic material of Comparative Example 4 and a powder magnetic core of Comparative Example 4 were fabricated using the same process as in Comparative Example 3, except that the temperature was increased to 600° C. and then the temperature was maintained at 600° C. for one hour during the heat treatment.

### [Evaluation]

Measurements were made for various performances of the powder magnetic cores of Examples 1 to 4 and Comparative Examples 1 to 4. The evaluation results are shown in Table 1.

Note that the evaluation of magnetic properties was made by measuring a core loss (iron loss (W/g)) and a magnetic permeability at 1T and 1 kHz using a BH analyzer (product number “SY-8258” manufactured by IWASTU INSTRUMENTS CORPORATION). The strength was evaluated by measuring the radial crushing strength of each toroidal core using a transverse strength tester (product number “1311D” manufactured by AIKOH ENGINEERING CO., LTD.). The density (g/cm³) was obtained from the weight and the volume of each toroidal core, the weight being measured by an electronic balance and the volume being measured by a micrometer. The value of resistance (mΩ) and the electrical resistance (mΩ·cm) were obtained as follows: the values of resistance at the opposite ends of each toroidal core were measured using an ohmmeter (Model 3569 or 3568 manufactured by TSURUGA ELECTRIC CORPORATION) and then the measurements were converted to an electrical resistance of a rod-shaped sample based on an equation below.

Electrical resistance=(20.343×actual measurement)+418.92)

TABLE 1

| | Heat | Value of | Electrical | | | Magnetic | Core Loss |
|---|---|---|---|---|---|---|---|
| | Treatment | Resistance | Resistance | Density | Strength | Permeability | (W/kg) |
| | Temp.(° C.) | (mΩ) | (μΩ · cm) | (g/cm³) | (MPa) | (@1 T/1 kHz) | @1 T. 1 kHz |
| Ex. 1 | 550 | 392 | 8393 | 7.686 | 120 | 703 | 105 |
| Ex. 2 | 550 | 572 | 12055 | 7.663 | 98 | 623 | 99 |
| Ex. 3 | 600 | 274 | 5997 | 7.633 | 129 | 718 | 99 |
| Ex. 4 | 600 | 178 | 4040 | 7.674 | 95 | 686 | 96 |
| Comp. Ex. 1 | 550 | 32 | 1073 | 7.699 | 95 | 840 | 120 |
| Comp. Ex. 2 | 600 | 1 | 443 | 7.661 | 70 | 236 | 911 |
| Comp. Ex. 3 | 550 | 54 | 1514 | 7.650 | 159 | 740 | 113 |
| Comp. Ex. 4 | 600 | 4 | 493 | 7.637 | 127 | 606 | 300 |

As shown in Table 1, the powder magnetic cores of Examples 1 to 4 each exhibited significantly high core resistance (the value of resistance and electrical resistance) and significantly low core loss, as compared to those of the powder magnetic cores of Comparative Examples 1 to 4. The powder magnetic cores of Examples 1 to 4 were each verified to have a high density of greater than 7.60 (g/cm³) and have sufficient performance in terms of strength and magnetic permeability. The powder magnetic cores of Examples 3 and 4 each had higher heat resistance than those of the powder magnetic cores of Comparative Examples 2 and 4, where degradation in performance was suppressed even in a high-temperature treatment of about 600° C. The powder magnetic cores of Examples 3 and 4 were verified to not only exhibit high core resistance (the value of resistance and electrical resistance) and low core loss, but also exhibit sufficient performance in terms of green density, magnetic permeability and strength.

### Examples 5 to 9

Soft magnetic materials of Examples 5 to 9 and powder magnetic cores of Examples 5 to 9 were fabricated using the same process as in Example 1, except that the content of the metal complex was changed as shown in Table 2.

### Examples 10 to 16

Soft magnetic materials of Examples 10 to 16 and powder magnetic cores of Examples 10 to 16 were fabricated using the same process as in Example 2, except that the content of the respective metal complex was changed as shown in Table 2.

### [Evaluation]

Measurements were made for various performances of the powder magnetic cores of Examples 1, 2 and 5 to 16. The evaluation results are shown in Tables 2 and 3.

TABLE 2

| | Content of | Value of | Electrical | | | Magnetic | Core Loss |
|---|---|---|---|---|---|---|---|
| | Metal | Resistance | Resistance | Density | Strength | Permeability | (W/kg) |
| | Complex (mol %) | (mΩ) | (μΩ · cm) | (g/cm³) | (MPa) | (@1 T/1 kHz) | @1 T. 1 kHz |
| Ex. 5 | 0.003 | 241 | 5326 | 7.679 | 102 | 794 | 104 |
| Ex. 6 | 0.015 | 315 | 6833 | 7.688 | 98 | 765 | 99 |
| Ex. 7 | 0.029 | 329 | 7116 | 7.677 | 105 | 703 | 102 |
| Ex. 1 | 0.057 | 392 | 8393 | 7.686 | 120 | 703 | 105 |
| Ex. 8 | 0.086 | 352 | 7574 | 7.624 | 146 | 604 | 103 |
| Ex. 9 | 0.114 | 341 | 7362 | 7.600 | 145 | 537 | 105 |

TABLE 3

| | Content of | Value of | Electrical | | | Magnetic | Core Loss |
|---|---|---|---|---|---|---|---|
| | Metal | Resistance | Resistance | Density | Strength | Permeability | (W/kg) |
| | Complex (mol %) | (mΩ) | (μΩ · cm) | (g/cm³) | (MPa) | (@1 T/1 kHz) | @1 T. 1 kHz |
| Ex. 10 | 0.057 | 205 | 4581 | 7.688 | 103 | 747 | 106 |
| Ex. 11 | 0.114 | 215 | 4785 | 7.711 | 98 | 694 | 102 |
| Ex. 12 | 0.171 | 233 | 5155 | 7.680 | 92 | 656 | 98 |
| Ex. 13 | 0.228 | 562 | 11852 | 7.659 | 93 | 658 | 99 |
| Ex. 2 | 0.285 | 572 | 12055 | 7.663 | 98 | 623 | 99 |
| Ex. 14 | 0.342 | 986 | 20473 | 7.699 | 103 | 587 | 99 |
| Ex. 15 | 0.399 | 1033 | 21433 | 7.679 | 103 | 586 | 104 |
| Ex. 16 | 0.456 | 1198 | 24790 | 7.664 | 102 | 528 | 105 |

The results shown in Tables 2 and 3 indicate that the powder magnetic cores of Examples 1, 2, 5 to 16 each exhibited significantly high core resistance (the value of resistance and electrical resistance) and significantly low core loss. Also, the powder magnetic cores of Examples 1, 2, 5 to 16 were each verified to have a high density of greater than 7.60 (g/cm³) and have sufficient performance in terms of strength and magnetic permeability. It was verified that, when a metal complex containing Zr as the central metal was used, a powder magnetic core having excellent strength was obtained as compared to the case where a metal complex containing Al as the central metal was used.

### Example 17

A soft magnetic material of Example 17 and a powder magnetic core of Example 17 were fabricated using the same process as in Example 1, except that the temperature was increased to 450° C. and then the temperature was maintained at 450° C. for one hour during the heat treatment.

### Example 18

A soft magnetic material of Example 18 and a powder magnetic core of Example 18 were fabricated using the same process as in Example 2, except that the temperature was increased to 450° C. and then the temperature was maintained at 450° C. for one hour during the heat treatment.

TABLE 4

| | Heat | Value of | Electrical | | | Magnetic | Core Loss |
|---|---|---|---|---|---|---|---|
| | Treatment | Resistance | Resistance | Density | Strength | Permeability | (W/kg) |
| | Temp. (° C.) | (mΩ) | (μΩ · cm) | (g/cm³) | (MPa) | (@1 T/1 kHz) | @1 T. 1 kHz |
| Ex. 17 | 450 | 855 | 17820 | 7.694 | 99 | 536 | 115 |
| Ex. 18 | 450 | 839 | 17491 | 7.667 | 102 | 502 | 116 |

The results shown in Table 4 indicate that the powder magnetic cores of Examples 17 and 18 each exhibited significantly high core resistance (the value of resistance and electrical resistance) even at the heat treatment temperature of 450° C., had a high density of greater than 7.60 (g/cm³), and in addition, had sufficient performance in terms of core loss, magnetic permeability and strength.

### Example 19

A soft magnetic material of Example 19 and a powder magnetic core of Example 19 were fabricated using the same process as in Example 1, except that zirconium tributoxyacetylacetonate was used instead of zirconium tetraacetylacetonate.

### Example 20

A soft magnetic material of Example 20 and a powder magnetic core of Example 20 were fabricated using the same process as in Example 1, except that zirconium butoxyacetylacetonate was used instead of zirconium tetraacetylacetonate.

### Example 21

A soft magnetic material of Example 21 and a powder magnetic core of Example 21 were fabricated using the same process as in Example 1, except that aluminum trisethyl acetoacetate was used instead of zirconium tetraacetylacetonate. Note that the content of the metal complex was 0.114 mol % on the basis of the ratio of aluminum to iron contained in the pure iron powder coated with the insulating film.

### Example 22

A soft magnetic material of Example 22 and a powder magnetic core of Example 22 were fabricated using the same process as in Example 1, except that aluminum bisethyl acetoacetate monoacetylacetonate was used instead of zirconium tetraacetylacetonate. Note that the content of the metal complex was 0.114 mol % on the basis of the ratio of aluminum to iron contained in the pure iron powder coated with the insulating film.

TABLE 5

| | Value of | Electrical | | | Magnetic | Core Loss |
|---|---|---|---|---|---|---|
| | Resistance | Resistance | Density | Strength | Permeability | (W/kg) |
| | (mΩ) | (μΩ · cm) | (g/cm³) | (MPa) | (@1 T/1 kHz) | @1 T. 1 kHz |
| Ex. 19 | 183 | 4136 | 7.698 | 92 | 615 | 103 |
| Ex. 20 | 220 | 4894 | 7.694 | 95 | 666 | 100 |
| Ex. 21 | 192 | 4325 | 7.681 | 103 | 672 | 99 |
| Ex. 22 | 403 | 8617 | 7.662 | 105 | 622 | 99 |

The results shown in Table 5 indicate that the powder magnetic cores of examples 19 to 22 each exhibited significantly high core resistance (the value of resistance and electrical resistance) and significantly low core loss as in Examples 1 to 16 above. Also, the powder magnetic cores of examples 19 to 22 each had a high density of greater than 7.60 (g/cm³), and had sufficient performance in terms of magnetic permeability and strength.

Note that, as mentioned above, the present invention is not limited to the embodiments and Examples described above, and modifications may be appropriately made without departing from the gist of the invention.

### INDUSTRIAL APPLICABILITY

As described above, the soft magnetic material, as well as the powder magnetic core and the method for manufacturing the same according to the present invention can be widely and effectively applied to electric and magnetic devices such as motors, generators and reactors, as well as various types of appliances, equipment and systems provided therewith.

1. A soft magnetic material comprising:
a core particle having a soft magnetic particle comprising iron as a main component thereof and an insulating film formed on a surface of the soft magnetic particle; and
a coating layer formed on the core particle,
wherein the coating layer comprises a metal complex having a nonferrous central metal and at least one organic ligand.

2. The soft magnetic material according to claim 1,
wherein at least one multidentate ligand is contained as the organic ligand.

3. The soft magnetic material according to claim 1,
wherein the metal complex is a metal chelate complex.

4. The soft magnetic material according to claim 1,
wherein the nonferrous central metal of the metal complex is contained in an amount from 0.001 to 1.0 mol % with respect to the iron contained in the core particle.

5. The soft magnetic material according to claim 1,
wherein the nonferrous central metal is at least one type selected from the group consisting of Al, Mg, Mn, Ti, Co and Zr.

6. The soft magnetic material according to claim 1,
wherein the soft magnetic particle contains 95% or more iron.

7. A soft magnetic material obtainable by: applying a metal complex having a nonferrous central metal and at least one organic ligand onto a core particle having a soft magnetic particle containing iron as a main component and an insulating film formed on the soft magnetic particle; and thereby forming a coating layer.

8. A method of manufacturing a powder magnetic core, comprising at least the steps of:
warm-compacting a mixture containing the soft magnetic material according to claim 1 and a lubricant; and
performing a heat treatment for a compact obtained after the warm-compaction.

9. The method according to claim 8,
wherein in the step of warm-compaction, the compaction is carried out at a temperature from 80° C. to 200° C.

10. The method according to claim 8,
wherein in the step of performing the heat treatment, the heat treatment is carried out at a temperature from 450° C. to 600° C.

11. The method according to claim 8,
wherein in the step of performing the heat treatment, the heat treatment is carried out in an oxygen-containing atmosphere.

12. A powder magnetic core fabricated by performing heat treatment for a compact that is obtainable by warm-compacting a mixture containing the soft magnetic material according to claim 1 and a lubricant.

13. The powder magnetic core according to claim 12,
wherein a green density is 7.60 g/cm3 or higher.
